(19) United States
(12) Patent Application Publication
(10) Pub. No.: US 2017/0120981 A1
(43) Pub. Date: May 4, 2017

(54) Arrangement for fitting a speed measuring device on a bicycle

(71) Applicant: Derby Cycle Werke GmbH, Cloppenburg (DE)

(72) Inventor: Holger KRAUSS, Schorndorf (DE)

(21) Appl. No.: 15/338,934

(22) Filed: Oct. 31, 2016

(30) Foreign Application Priority Data
Oct. 31, 2015 (DE) 20 2015 007 540.1

(51) Int. Cl. B62K 19/40; B62J 99/00

(52) U.S. Cl. CPC B62K 19/40; B62J 99/00; B62J 2099/002; B62K 2207/00

(57) ABSTRACT

With an arrangement for fitting a speed measuring device on a bicycle provision is made for at least one dropout end of a frame of the bicycle to comprise a constructional space for fitting at least one speed sensor and for a triggering element corresponding with the speed sensor in a triggering manner to be arranged on a component of the wheel fitted into the dropout end.

### BACKGROUND OF THE INVENTION

Field of the Invention

The invention relates to an arrangement for fitting a speed measuring device (speedometer) on a bicycle.

Brief Description of the Related Art

Many users of bicycles are interested in the speed achieved by them when going for a cycle ride. For this reasons speed measuring devices called bicycle computers are regularly offered on the market which after being fitted to the bicycle can inform the users of bicycles about the momentary speed and also the average speed.

Known speedometers comprise a speed sensor, which for example is attached by means of cable binders to the front wheel fork. A spoke of the front wheel has a triggering element corresponding with the speed sensor attached to it, which while being guided past the speed sensor triggers pulses during the trip.

It is known that speedometers sometimes malfunction. The association of triggering element and speed sensor is not always correct, so that from time to time corrections are made by bicycle users to the way in which the triggering element is arranged. In addition installation of a speed sensor is known to be difficult because despite the use of strong cable ties, it is possible for the speed sensor to slip.

### SUMMARY OF THE INVENTION

The invention is based on the requirement to propose an arrangement mentioned in the beginning, with which a simple installation of the components of the speedometer on a bicycle is possible.

According to the invention this requirement is met in that at least one dropout end of a frame of the bicycle comprises a constructional space for fitting at least one speed sensor and in that a triggering element corresponding with the speed sensor in a triggering manner is arranged on a component of the wheel fitted into the dropout end.

With the arrangement according to the invention the triggering element may be arranged on a wheel as is the case in the state of the art. The wheel, for example the rear wheel of the bicycle, is fitted into the dropout end and via this is connected to the frame of the bicycle. According to the invention the already existing dropout end is used to receive the speed sensor of a speedometer. An additional arrangement with cable ties, for example on a front wheel fork, is no longer necessary. Within the dropout end the speed sensor can be received in such a way that it is positionally stable and protected against environmental influences.

According to a further development of the invention provision is made for the speed sensor to comprise an outer contour which is adapted to the constructional space of the dropout end. The speed sensor may be provided with a housing, which is formable due to appropriate machining. The outer contour and thus the outer shape of the housing can then be adapted to match an inner contour of the constructional space existing in the dropout end, so that the speed sensor can snuggle into the dropout end. The existence of any remaining cavities in the dropout end can thus be reduced preventing any dirt from accumulating there. A cable leading to the speed sensor can then be run along a frame strut, for example along a chain strut. It is also possible to run the cable within a frame strut.

The triggering element of the speed measuring device may be attached to a spoke as in the state of the art. According to a further development however, it is attached directly to the wheel axle, to which end a ring is provided which is pushed onto the wheel axle, which comprises a projection on which the triggering element is arranged. This form of construction can be implemented in a very space-saving manner, subsequent attachment of components to spokes is not necessary.

Alternatively provision may be made for the triggering element to be arranged on a brake disk of a disk brake non-rotatably connected to the wheel axle. The brake disk of a disk brake is non-rotatably connected to the axle so that rotations of the axle are transferred to the brake disk. Not all sections of the brake disk are received between the brake shoes of the disk brake, there are remaining sections which act as supports. These can serve as a means for attaching the triggering element for the speed sensor.

### BRIEF DESCRIPTION OF THE DRAWING

Exemplary embodiments of the invention revealing further inventive features are shown in the drawing, in which:

FIG. 1: shows a perspective view of a dropout end of a frame with installed speed sensor and triggering element;

FIG. 2: shows a further perspective view of the dropout end of FIG. 1;

FIG. 3: shows a perspective view of a first option for receiving the speed sensor; and

FIG. 4: shows a perspective partial view of a brake disk of a disk brake with a further option for receiving the triggering element of FIG. 1.

### DETAILED DESCRIPTION OF THE PREFERRED EMBODIMENTS

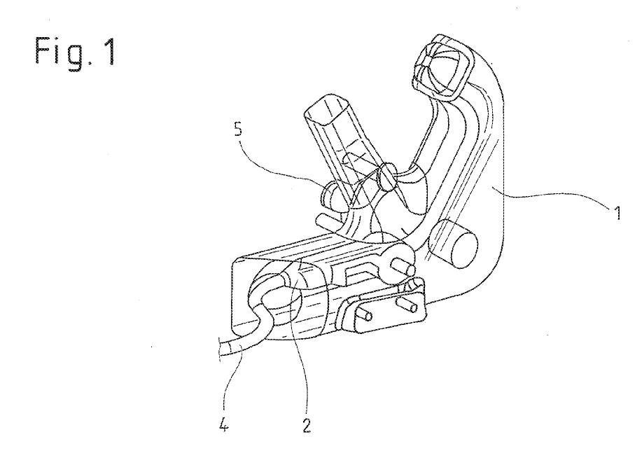

FIG. 1 shows a dropout end 1 for a bicycle frame. The dropout end 1 can, for example, receive the rear wheel of the bicycle.

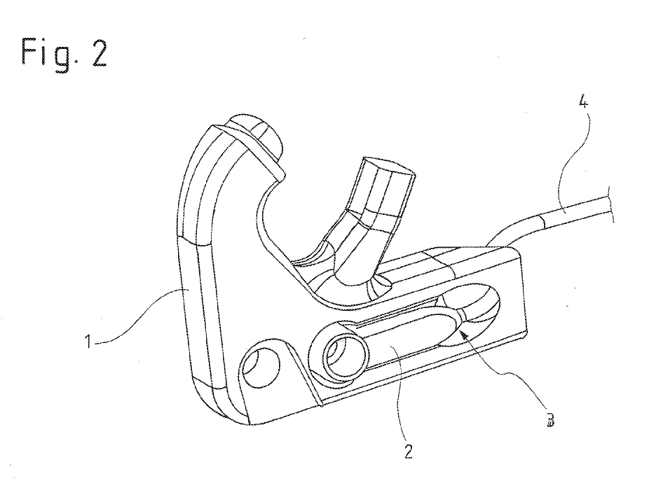

According to the invention a speed sensor 2 is provided at the dropout end 1. The dropout end 1 comprises a constructional space 3 for this, which is shown in FIG. 2. The speed sensor 2 has a cable 4 connected to it. The speed sensor 2 is formed in such a way that it can be fitted into the constructional space 3 of the dropout end 1 in a form-locked manner. On one side surface of the speed sensor 2 there is an indentation, into which a projection 6 of the material of the dropout end 1 protrudes. This ensures that the speed sensor 2 is received in it so as to be positionally stable.

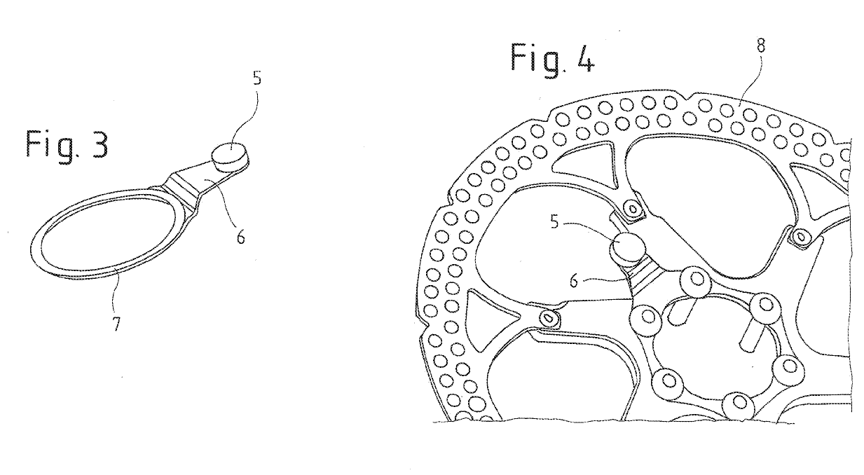

FIG. 1 also shows the triggering element 5 for the speed sensor 2. The triggering element 5 may, for example, be a permanent magnet. FIGS. 3 and 4 show different ways for attaching the triggering element 5 to the wheel to be received in the dropout end 1. According to FIG. 3 the triggering element 5 is arranged on a projection 6, which is attached to a ring 7. The ring 7 may be pushed onto the axle of the wheel and non-rotatably attached there. Alternatively, as shown in FIG. 4, the triggering element 5 can be arranged via a projection 6 on the brake disk 8 of a disk brake. The brake disk 8 is also non-rotatably attached to the wheel, which is received at the dropout end 1.

All features mentioned in the above description and in the claims can be randomly selected and combined with the features of the independent claim. The disclosure of the invention is thus not limited to the described/claimed feature combinations, rather all feature combinations meaningful in terms of the invention are considered to be disclosed.

1. An arrangement for fitting a speed measuring device on a bicycle,
wherein
at least one dropout end of a frame of the bicycle comprises a constructional space for fitting at least one speed sensor and in that a triggering element corresponding with the speed sensor in a triggering manner is arranged on a component of the wheel fitted into the dropout end.

2. The arrangement according to claim 1, wherein the speed sensor has an outer contour adapted to match the constructional space of the dropout end (1).

3. The arrangement according to claim 1, wherein at least one cable leading to the speed sensor can be run along a frame strut.

4. The arrangement according to claim 1, wherein the triggering element is attached to the wheel axle.

5. The arrangement according to claim 4, wherein in order to attach the triggering element a ring is pushed onto the wheel axle, wherein a projection is arranged on the ring and the triggering element is attached to this projection.

6. The arrangement according to claim 1, wherein the triggering element is arranged on a brake disk of a disk brake non-rotatably connected to the wheel axle.
